(19) United States
(12) Patent Application Publication
(10) Pub. No.: US 2022/0351059 A1
(43) Pub. Date: Nov. 3, 2022

(54) SENTENCE CLASSIFICATION USING ENHANCED KNOWLEDGE FROM TEXTUAL KNOWLEDGE BASES

(71) Applicant: International Business Machines Corporation, Armonk, NY (US)

(72) Inventors: Thanh Lam Hoang, Maynooth (IE); Gabriele Picco, Dublin (IE); Marco Luca Sbodio, Castaheany (IE); Vanessa Lopez Garcia, Dublin (IE); Natalia Mulligan, Dublin (IE); Joao H Bettencourt-Silva, Dublin (IE)

(21) Appl. No.: 17/244,315

(22) Filed: Apr. 29, 2021

(51) Int. Cl. G06N 5/04; G06N 5/02; G06N 3/08; G06F 16/35

(52) U.S. Cl. CPC G06N 5/045; G06N 5/025; G06N 5/022; G06N 3/08; G06F 16/35

(57) ABSTRACT

Methods, computer program products, and/or systems are provided that perform the following operations: obtaining a textual knowledge base; filtering the textual knowledge base to obtain a subset of the textual knowledge base, wherein the filtering is based on textual query data; generating reasoning data based on the subset of the textual knowledge base and the textual query data; generating classification data based on the subset of the textual knowledge base, the textual query data, and the reasoning data; and providing label data as output for the textual query data based on the classification data.

### BACKGROUND

The present invention relates generally to the field of text classification, and more particularly to providing for classification of textual queries using enhanced knowledge from textual knowledge bases.

### SUMMARY

According to an aspect of the present invention, there is a method, computer program product and/or system that performs the following operations (not necessarily in the following order): obtaining a textual knowledge base; filtering the textual knowledge base to obtain a subset of the textual knowledge base, wherein the filtering is based on textual query data; generating reasoning data based on the subset of the textual knowledge base and the textual query data; generating classification data based on the subset of the textual knowledge base, the textual query data, and the reasoning data; and providing label data as output for the textual query data based on the classification data.

### BRIEF DESCRIPTION OF THE DRAWINGS

FIG. 1 depicts a block diagram view of a first embodiment of a system, according to the present invention;

FIG. 2 depicts a flowchart showing a first embodiment method performed, at least in part, by the first embodiment system;

FIG. 3 depicts a block diagram showing an example machine logic (for example, software) portion of the first embodiment system;

FIG. 4 depicts a block diagram of an example system architecture for textual sentence classification using enhanced knowledge from a knowledge base, according to embodiments of the present invention;

FIG. 5 depicts a block diagram of an example relevant knowledge filter, according to embodiments of the present invention;

FIG. 6 depicts a block diagram of an example backward reasoning module, according to embodiments of the present invention; and

FIG. 7 depicts a block diagram of an example forward reasoning module, according to embodiments of the present invention.

### DETAILED DESCRIPTION

According to aspects of the present disclosure, systems and methods can be provided to generate classification labels for a textual sentence, for example, as part of a response to a textual query. In particular, systems and methods of the present disclosure can provide for generating classification labels associated with a textual query based on data included as part of a large knowledge base. The systems and methods of the present disclosure can provide for filtering a large textual knowledge base using a relevant knowledge filter to extract a subset of the data included in the textual knowledge base. In some embodiments, the textual knowledge base includes a plurality of facts and rules. The systems and methods of the present disclosure can provide for using a reasoner to perform fact checking on data included in the subset of the textual knowledge base and/or to generate new facts which can be included with the subset of the textual knowledge base for use in answering the query. The systems and methods of the present disclosure can provide for using a classifier to generate label(s) for the textual query as output for use in answering the query. In some embodiments, the systems and methods can provide for generating answers to textual queries that include classification label(s) and human interpretable explanation(s) based on data (e.g., facts and rules, etc.) included in the textual knowledge base and/or new data (e.g., facts. Rules, etc.) generated by the reasoner.

In general, sentence classification can be an important application field in natural language processing (NLP). Often, approaches for sentence classification problems make use of domain knowledge for enhancing text representation with domain information from knowledge bases to improve classification accuracy. Generally, much domain knowledge is represented in a formal format, like knowledge graphs, or with abstract definitions using formal ontology languages. With advances in the deep learning field with many applications in NLP, formal representation of knowledge bases is being revisited in favor of informal representations. As an example, a knowledge base including facts and rules can now be represented in natural language. This type of knowledge base representation can provide advantages over other types of knowledge bases, in part, for example, due to its high expressiveness, its ready availability (e.g., in the internet, etc.), and because humans often prefer to document their knowledge in natural language.

Accordingly, embodiments of the present disclosure can provide for classifying text sentences, paragraphs, and/or the like, for example, included in a textual classification query, using enhanced knowledge from one or more knowledge bases that are expressed in a natural language format.

In general, a textual knowledge base can include two types of information: facts and rules. Facts can include factual information about entities, such as entity properties, relations, and/or the like, for example. Rules can include first order and/or higher order logic rules that may, in some cases, be expressed in natural language.

As an example, a textual knowledge base might include:

Example Textual Knowledge Base

Facts:
Elephant is the biggest animal in the forest
Tiger lives in forest
Tiger cannot fit in a small car
Horse eats grass
Anne has a cat
Anne likes video games
John is Mary’s husband
. . .
Rules:
All father loves what their daughters like
If X is a daughter of Y then Y is a father of X
If someone has a dog then they may not have a cat
If a cat eats dog food then it becomes a fat cat
If x does not fit z and y is bigger than x then y does not fit z
If x is the biggest in z and y lives in z then x is bigger than y
. . .

Text classification of text fragments (e.g., sentences, etc.) can include assigning classification labels to the text fragments, for example, in fact checking, sentiment analysis, and/or the like. As an example, fact checking a text might include classification of a sentence like “John loves video games” using a “yes” (true) or “no” (false) label. As another example, sentiment analysis might include classification of a sentence like “Ha, ha, it sounds like I see an elephant in my car” using labels such as “happy,” “neutral,” “not happy,” “joke,” and/or the like.

As one example approach, a knowledge base may be concatenated with text to create a single big fragment of text. For example, concatenating to create a single fragment of text such as “[CLS] Facts [SEP] Rules [SEP] text [SEP]” or the like. The single big fragment of text may then be provided as an input, for example, to a transformer, to classify the given big fragment of text. However, a knowledge base may include many redundant facts and/or rules. Using all the information in the knowledge base may result in disadvantages such as overwhelming the transformer, requiring a lot of training data for the transformers to learn to match a given text with useful information from the knowledge base for the text classification, and/or the like.

Therefore, according to aspects of the present disclosure, systems and methods can be provided to classify textual sentences, for example, a textual query and/or the like using enhanced knowledge from one or more knowledge bases. For example, embodiments of the present disclosure can provide for filtering a textual knowledge base to extract a subset of relevant data (facts, rules, etc.) for a given textual sentence; forward and/or backward reasoning to provide fact checking and/or to generate new facts; providing classifications for a given textual sentence (e.g., labels, etc.), and/or the like. As an example, some embodiments of the present disclosure can, based on facts and/or rules and query text, perform reasoning to, for example, generate new useful facts (e.g., forward inference, etc.), generate simpler queries (e.g., backward inference, etc.), and/or the like, that may help label (e.g., classify, etc.) queries more accurately by using logical inference in consideration of rules provided in a knowledge base.

This Detailed Description section is divided into the following sub-sections: The Hardware and Software Environment; Example Embodiments; Further Comments and/or Embodiments; and Definitions.

The Hardware and Software Environment

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

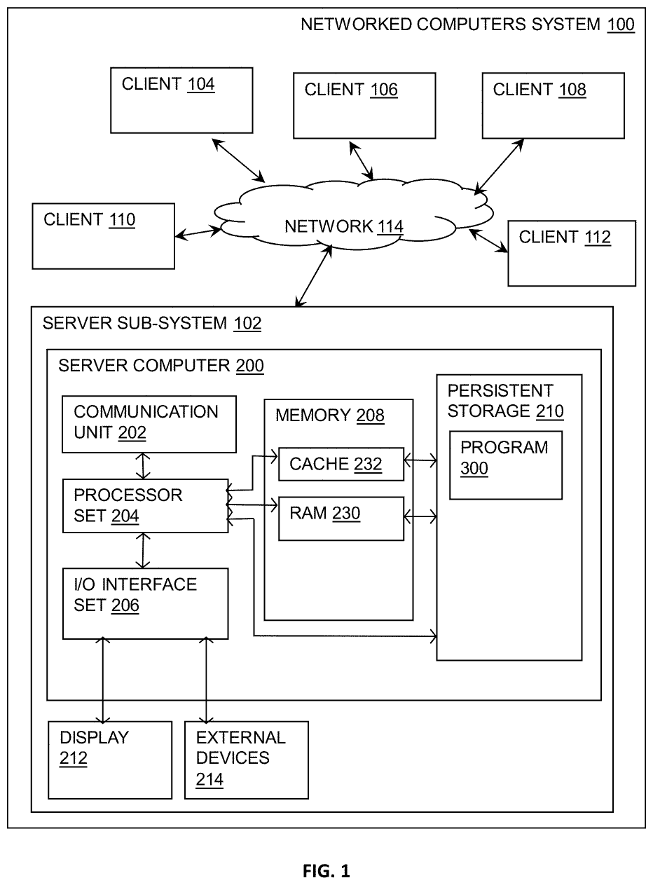

An embodiment of a possible hardware and software environment for software and/or methods according to the present invention will now be described in detail with reference to the Figures. FIG. 1 is a functional block diagram illustrating various portions of networked computers system 100, including: server sub-system 102; client sub-systems 104, 106, 108, 110, 112; communication network 114; server computer 200; communication unit 202; processor set 204; input/output (I/O) interface set 206; memory device 208; persistent storage device 210; display device 212; external device set 214; random access memory (RAM) devices 230; cache memory device 232; and program 300.

Sub-system 102 is, in many respects, representative of the various computer sub-system(s) in the present invention. Accordingly, several portions of sub-system 102 will now be discussed in the following paragraphs.

Sub-system 102 may be a laptop computer, tablet computer, netbook computer, personal computer (PC), a desktop computer, a personal digital assistant (PDA), a smart phone, or any programmable electronic device capable of communicating with the client sub-systems via network 114. Program 300 is a collection of machine-readable instructions and/or data that can be used to create, manage, and control certain software functions, such as will be discussed in detail, below, in the Example Embodiment sub-section of this Detailed Description section. As an example, a program 300 can generate classification labels for a query (e.g., textual query sentence, paragraph, etc.); filter a large knowledge base to extract relevant data; perform reasoning to provide fact checking, generate mew useful facts, and/or generate simpler queries; generate query response based on classification labels; generate explanations as part of a query response based on knowledge base data; provide for using feedback relative to query answers (e.g., labels, etc.) and/or explanations to improve filtering, reasoning, classification, etc.; and/or the like.

Sub-system 102 is capable of communicating with other computer sub-systems via network 114. Network 114 can be, for example, a local area network (LAN), a wide area network (WAN) such as the Internet, or a combination of the two, and can include wired, wireless, or fiber optic connections. In general, network 114 can be any combination of connections and protocols that will support communications between server and client sub-systems.

Sub-system 102 is shown as a block diagram with many double arrows. These double arrows (no separate reference numerals) represent a communications fabric, which provides communications between various components of sub-system 102. This communications fabric can be implemented with any architecture designed for passing data and/or control information between processors (such as microprocessors, communications and network processors, etc.), system memory, peripheral devices, and any other hardware components within a system. For example, the communications fabric can be implemented, at least in part, with one or more buses.

Memory 208 and persistent storage 210 are computer-readable storage media. In general, memory 208 can include any suitable volatile or non-volatile computer-readable storage media. It is further noted that, now and/or in the near future: (i) external device(s) 214 may be able to supply, some or all, memory for sub-system 102; and/or (ii) devices external to sub-system 102 may be able to provide memory for sub-system 102.

Program 300 is stored in persistent storage 210 for access and/or execution by one or more of the respective computer processors 204, usually through one or more memories of memory 208. Persistent storage 210: (i) is at least more persistent than a signal in transit; (ii) stores the program (including its soft logic and/or data), on a tangible medium (such as magnetic or optical domains); and (iii) is substantially less persistent than permanent storage. Alternatively, data storage may be more persistent and/or permanent than the type of storage provided by persistent storage 210.

Program 300 may include both machine readable and performable instructions and/or substantive data (that is, the type of data stored in a database). For example, program 300 may include machine readable and performable instructions to provide for performance of method operations as disclosed herein. In this particular embodiment, persistent storage 210 includes a magnetic hard disk drive. To name some possible variations, persistent storage 210 may include a solid-state hard drive, a semiconductor storage device, read-only memory (ROM), erasable programmable read-only memory (EPROM), flash memory, or any other computer-readable storage media that is capable of storing program instructions or digital information.

The media used by persistent storage 210 may also be removable. For example, a removable hard drive may be used for persistent storage 210. Other examples include optical and magnetic disks, thumb drives, and smart cards that are inserted into a drive for transfer onto another computer-readable storage medium that is also part of persistent storage 210.

Communications unit 202, in these examples, provides for communications with other data processing systems or devices external to sub-system 102. In these examples, communications unit 202 includes one or more network interface cards. Communications unit 202 may provide communications through the use of either or both physical and wireless communications links. Any software modules discussed herein may be downloaded to a persistent storage device (such as persistent storage device 210) through a communications unit (such as communications unit 202).

I/O interface set 206 allows for input and output of data with other devices that may be connected locally in data communication with server computer 200. For example, I/O interface set 206 provides a connection to external device set 214. External device set 214 will typically include devices such as a keyboard, keypad, a touch screen, and/or some other suitable input device. External device set 214 can also include portable computer-readable storage media such as, for example, thumb drives, portable optical or magnetic disks, and memory cards. Software and data used to practice embodiments of the present invention, for example, program 300, can be stored on such portable computer-readable storage media. In these embodiments the relevant software may (or may not) be loaded, in whole or in part, onto persistent storage device 210 via I/O interface set 206. I/O interface set 206 also connects in data communication with display device 212.

Display device 212 provides a mechanism to display data to a user and may be, for example, a computer monitor, a smart phone/tablet display screen, and/or the like.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

### Example Embodiments

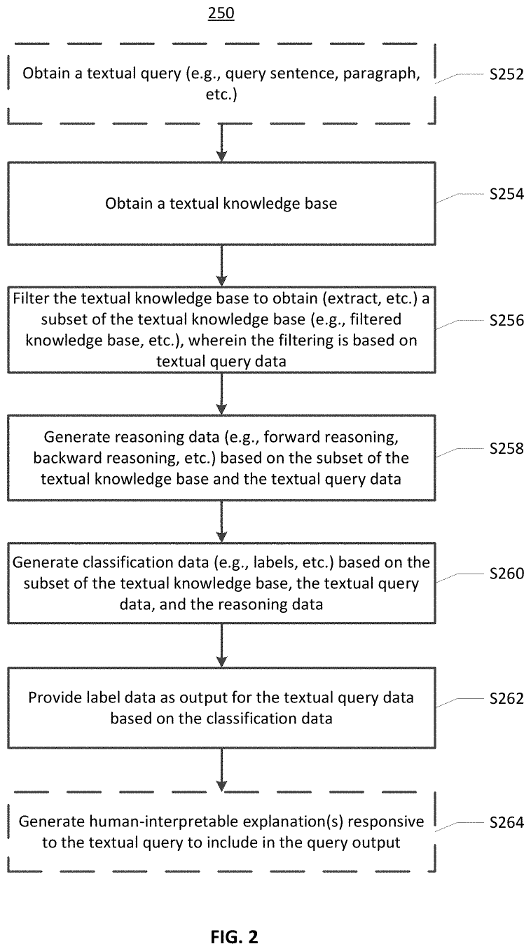

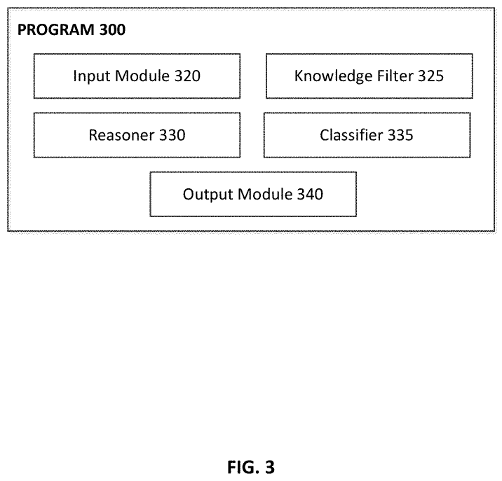

FIG. 2 shows flowchart 250 depicting a computer-implemented method, according to embodiment(s) of the present invention. FIG. 3 shows a program 300 for performing at least some of the method operations of flowchart 250. Regarding FIG. 2, one or more flowchart blocks may be identified with dashed lines and represent optional steps that may additionally be included, but which are not necessarily required, in the depicted embodiments. This method and associated software will now be discussed, over the course of the following paragraphs, with extensive reference to FIG. 2 (for the method operation blocks) and FIG. 3 (for the software blocks).

As illustrated in FIG. 2, in some embodiments, operations for generating labels and/or associated data responsive to a textual query may optionally begin at operation S252, where a computing system (e.g., server computer 200 of FIG. 1 or the like) may obtain textual query data (e.g., a query sentence, query paragraph, etc.). As an example, an input module 320 of FIG. 3 and/or the like can provide for obtaining a query (e.g., textual query sentence, paragraph, etc.), for example, from a user and/or the like. In some embodiments, the input module 320 and/or the like can provide the query to one or more other modules (e.g., knowledge filter 325, reasoner, 330, classifier 335, etc.) to provide for filtering a knowledge base, generating classification labels and/or other data responsive to the input query and/or the like. In some embodiments, the textual query data can include a textual sentence, paragraph, and/or the like that is to be classified to provide label data for use in providing responsive data for the textual query data (e.g., textual classification query, etc.).

Processing proceeds to (or, in some embodiments, may begin at) operation S254, where the computing system (e.g., server computer 200 of FIG. 1 or the like) obtains a textual knowledge base. As an example, an input module 320 and/or the like can provide for obtaining a knowledge base (e.g., large textual knowledge base, unfiltered knowledge base, etc.). In some embodiments, the input module 320 and/or the like can provide the knowledge base for use in generating labels and/or other output associated with a query (e.g., a textual query sentence, paragraph, etc.). In some embodiments, the textual knowledge base includes fact data and rule data. In some embodiments, the textual knowledge base may represent a large knowledge base and may include a significant number of facts and rules.

As an example, a textual knowledge base may include and/or represent a plurality of facts and rules, such as:

Original Textual Knowledge Base

Facts:
Elephant is the biggest animal in the forest
Tiger lives in forest
Tiger cannot fit in a small car
Horse eats grass
Anne has a cat
Anne likes video games
John is Mary’s husband
. . .
Rules:
All father loves what their daughters like
If X is a daughter of Y then Y is a father of X
If someone has a dog then they may not have a cat
If a cat eats dog food then it becomes a fat cat
If x does not fit z and y is bigger than x then y does not fit z
If x is the biggest in z and y lives in z then x is bigger than y
. . .

Processing proceeds to operation S256, where the computing system (e.g., server computer 200 of FIG. 1 or the like) filters the textual knowledge base. For example, the computing system filters the textual knowledge base to obtain (e.g., select, extract, etc.) a subset of the textual knowledge base (e.g., filtered knowledge base, etc.) and provide a filtered textual knowledge base (e.g., a subset of the original textual knowledge base). The computing system (e.g., relevant knowledge filter, etc.) filters the textual knowledge base (e.g., original textual knowledge base, etc.) based, at least in part, on textual query data (e.g., textual query sentence, paragraph, etc.). As an example, a knowledge filter 325 and/or the like can receive (e.g., access, obtain, etc.) a textual knowledge base (e.g., original knowledge base, etc.) and textual query data (e.g., a textual classification query, etc.) and filter (e.g., extract, select, etc.) and output a subset of the original textual database, for example, to use in generating labels and/or the like responsive to the textual query data (e.g., a textual classification query, etc.). For example, in some embodiments, the computing system (e.g., relevant knowledge filter 325, etc.) can extract and output a set of likely relevant facts and rules from those included in the original textual knowledge base that may be relevant for the given textual query data (e.g., textual classification query, etc.).

In some embodiments, the computing system (e.g., relevant knowledge filter 325, etc.) may implement the filtering of the textual knowledge base (e.g., extraction of a subset of the original knowledge base, etc.) based, at least in part, on entity linking, similarity search, and/or the like. In some embodiments, the computing system (e.g., relevant knowledge filter, etc.) can select (e.g., extract, etc.) relevant facts and/or rules from the original textual knowledge base in the context of the classification query (e.g., textual query data, etc.).

As an example, a filtered textual knowledge base (e.g., subset of an original knowledge base, etc.) may be filtered, for example, based in part on a query sentence (e.g., textual classification sentence, etc.), such as “Ha, ha, it sounds like I see an elephant in my car!”, and may include and/or represent a plurality of relevant facts and rules from the original knowledge base, such as:

Filtered Textual Knowledge Base

Facts:
Elephant is the biggest animal in the forest
Tiger lives in forest
Tiger cannot fit in a small car
Horse eats grass
. . .
Rules:
If x does not fit z and y is bigger than x then y does not fit z
If x is the biggest in z and y lives in z then x is bigger than y
. . .

Processing proceeds to operation S258, where the computing system (e.g., server computer 200 of FIG. 1 or the like) generate reasoning data. The reasoning data may be based, at least in part, on the subset of the textual knowledge base (e.g., filtered textual knowledge base, etc.), the textual query data (e.g., textual classification query, sentence, paragraph, etc.), and/or the like. The reasoning data can include fact check data (e.g., true, false), new useful facts and/or rules that may be relevant to the query, and/or the like. As an example, a reasoner 330 of FIG. 3 and/or the like can receive (e.g., access, obtain, etc.) the subset of the textual knowledge base (e.g., filtered knowledge base, etc.) and the textual query data (e.g., sentence, paragraph, etc. in textual form, etc.). The reasoner 330 of FIG. 3 and/or the like can generate reasoning output (e.g., based on the knowledge base facts and/or rules, the query text, etc.). In some embodiments, the reasoner 330 can include a forward reasoning module, a backward reasoning module, and/or the like and may perform backward reasoning and/or forward reasoning to generate reasoning data that may include fact check data (e.g., true, false), new useful facts and/or rules that may be relevant to the query, and/or the like.

In some embodiments, the reasoner 330 of FIG. 3 and/or the like can provide for generating simpler queries, for example, using backward inference and/or the like. In some embodiments, the reasoner can generate new useful facts and/or simpler queries that can help label queries more accurately by using logical inference considering rules provided in the knowledge base (e.g., filtered knowledge base, etc.).

In some embodiments, the computing system (e.g., reasoner 330, etc.) may perform backward reasoning, based on the subset of the textual knowledge base (e.g., filtered knowledge base, etc.) and the textual query data (e.g., textual classification query, sentence, paragraph, etc.), to generate fact check data (e.g., true, false, etc.) and/or the like. In some embodiments, a backward reasoning module may include a pretrained neural network(s) that can perform backward reasoning, including multi-step backward chaining inference and/or the like. In some embodiments, a backward reasoning module (e.g., reasoner 330, etc.) may include a unification neural network that may simulate unification steps in backward chaining inference. In some embodiments, the neural network(s) may be pretrained, for example, using supervised learning.

In some embodiments, the computing system (e.g., reasoner 330, etc.) may perform forward reasoning, based on the subset of the textual knowledge base (e.g., filtered knowledge base, etc.) and the textual query data (e.g., textual classification query, sentence, paragraph, etc.), to generate one or more new facts, one or more new rules, and/or the like relevant and/or useful for the query. In some embodiments, one or more new facts and/or rules may be generated given one or more query facts and multiple rules and/or facts extracted from the knowledge base. In some embodiments, a forward reasoning module may include a pretrained neural network(s) that can perform forward reasoning, including multi-step forward inference. In some embodiments, the neural network(s) may be pretrained, for example, using supervised learning.

In some embodiments, textual query data (e.g., input query text, facts, etc.) may be used to guide a reasoner (e.g., forward reasoning module, etc.) to generate only facts relevant to a given query (e.g., textual query data, etc.). In some embodiments, a forward reasoning module can provide one or more new facts that can be added to the filtered knowledge base (e.g., subset of the textual knowledge base, etc.) for use (e.g., by a classifier, etc.) in generating classification labels and/or the like for the textual query data. In some embodiments, a forward reasoning module can provide one or more new facts to a classifier and/or the like for use in generating classification labels and/or the like for the textual query data.

Processing proceeds to operation S260, where the computing system (e.g., server computer 200 of FIG. 1 or the like) generate classification data (e.g., classification labels, etc.) for the textual query data (e.g., textual classification query, sentence, paragraph, etc.). The computing system can generate the classification data based, at least in part, on the subset of the textual knowledge base (e.g., filtered textual knowledge base, etc.), the textual query data (e.g., textual classification query, sentence, paragraph, etc.), the reasoning data (e.g., true/false fact check data, new facts, etc.), and/or the like. As an example, a classifier 335 and/or the like can receive (e.g., access, obtain, etc.) the subset of the textual knowledge base, the textual query data, and/or the reasoning data and generate classification data (e.g., classification labels, etc.) and/or the like associated with the textual query data. In some embodiments, a classifier 335 and/or the like can generate classification data (e.g., classification labels, etc.) and/or the like for the textual query data (e.g., query sentence, paragraph, etc.) based, at least in part, on facts and/or rules included in the subset of the textual knowledge base, fact check (e.g., true/false) data from the reasoner, new relevant/useful facts from the reasoner, and/or the like. In some embodiments, the classifier 335 and/or the like can include a trained neural network(s) that can generate the classification data (e.g., classification labels, etc.) and/or the like. In some embodiments, the neural network(s) may be pretrained, for example, using supervised learning.

Processing proceeds to operation S262, where the computing system (e.g., server computer 200 of FIG. 1 or the like) provides label data as output for (e.g., responsive to, etc.) the textual query data (e.g., textual classification query, sentence, paragraph, etc.). The computing system can generate the label data based on the classification data associated with the textual query data. As an example, an output module 340 and/or the like receive (e.g., access, obtain, etc.) the classification data and/or the like and can provide label data associated with (e.g., responsive to, etc.) the textual query data (e.g., textual classification query, sentence, paragraph, etc.) as output.

Optionally, in some embodiments, processing may continue to operation S264, where the computing system (e.g., server computer 200 of FIG. 1 or the like) may generate a human-interpretable explanation(s) responsive to the textual query data. In some embodiments, the computing system may generate human-interpretable explanation(s) for the query based, at least in part, on the textual query data, data (e.g., facts, rules, etc.) from the subset of the textual knowledge base (e.g., filtered textual knowledge base, etc.), new facts/rules generated by the reasoner (e.g., reasoner 330, etc.), classification data (e.g., from classifier 335, etc.), and/or the like. As an example, in some embodiments, an output module 340 and/or the like may provide human-interpretable explanation(s) associated with (e.g., responsive to, etc.) the textual query data (e.g., textual classification query, sentence, paragraph, etc.). For example, in some embodiments, the computing system may provide output that includes classified sentence(s) with label(s) and explanation(s).

### Further Comments and/or Embodiments

Additionally, some embodiments of the present disclosure can provide for obtaining feedback related to (e.g., associated with, etc.) a textual query (e.g., textual query data, textual classification query, query sentence, query paragraph, etc.). The feedback may be obtained in relation to a textual query answer(s) (e.g., label, explanation, etc.), textual query label(s), textual query answer explanation(s), and/or the like. In some embodiments, the feedback may be used in updating, improving, etc. models used in relevant knowledge filtering, reasoning, classification, and/or the like.

Accordingly, in some embodiments, a computing system (e.g., server computer 200 of FIG. 1 or the like) can include an interactive mechanism (e.g., feedback module, etc.) that may provide and/or enable obtaining feedback, for example, via user interface(s), feedback backend(s), and/or the like. The computing system can (e.g., feedback module, etc.) may allow for users, human experts, and/or the like to provide feedback on an answer, label, explanation, and/or the like to a textual classification query. The computing system can (e.g., feedback module, etc.) provide for using the obtained feedback to improve result accuracy, for example, improving relevant knowledge filters, forward/backward reasoning (e.g., reasoning neural networks, etc.), classification (e.g., classification neural networks, etc.), query explanation generation, and/or the like. In some embodiments, the relevant knowledge filter, reasoner(s), classifier, explanation generator, and/or the like may include one or more models and the obtained feedback may be used in updating such models, for example, to improve accuracy and/or the like.

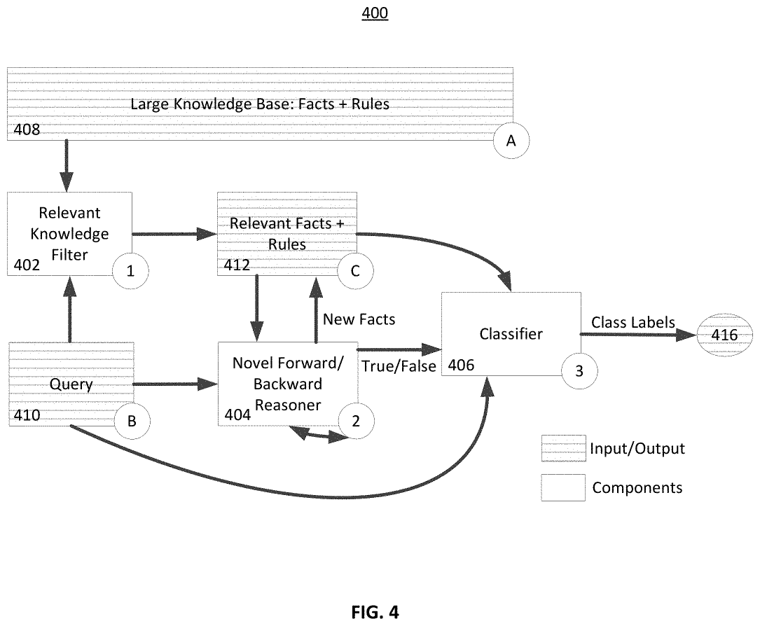

FIG. 4 is a block diagram showing an example architecture 400 for textual query (e.g., textual sentence, paragraph, etc.) classification and/or response generation using enhanced knowledge from a knowledge base, according to embodiments of the present invention. As illustrated in FIG. 4, in some embodiments, an architecture 400 for query classification/response may include a relevant knowledge filter 402, a reasoner 404, a classifier 406, and/or the like. The architecture 400 may provide for receiving a query (e.g., a textual sentence, paragraph, and/or the like), such as query 410, that is to be classified to provide a responsive output.

For example, as illustrated in FIG. 4, query 410 may be obtained (e.g., received, provided to, etc.) by a relevant knowledge filter 402 included in the architecture 400. The relevant knowledge filter 402 may also obtain (e.g., access, etc.) a large knowledge base 408 (e.g., textual knowledge base, etc.) which may include a plurality of facts and rules. The relevant knowledge filter 402 can select (e.g., extract, filter, etc.) a subset of data (e.g., facts, rules, etc.) included in the large knowledge base 408 that may be relevant to the query 410. The relevant knowledge filter 402 may be provided input including the large knowledge base 408 and the query 410 (e.g., textual classification query, etc.). The relevant knowledge filter 402 can generate (e.g., obtain, extract, etc.) a subset of the large knowledge base 408, for example, filtered knowledge base 412, that includes a set of likely relevant data (e.g., facts, rules, etc.) included in the large knowledge base 408. In some embodiments, the relevant knowledge filter 402 may be implemented with entity linking, similarity search, and/or the like. The relevant knowledge filter 402 can provide the filtered knowledge base 412 (e.g., relevant facts, rules, etc.) to the reasoner 404 included in the architecture 400.

The reasoner 404 can obtain (e.g., receive, be provided, etc.) the query 410 (e.g., textual classification query, sentence, paragraph, etc. in textual form, etc.) and the filtered knowledge base 412 (e.g., relevant facts, rules, etc.). In some embodiments, the reasoner 404 can include a forward reasoner and a backward reasoner. The reasoner 404 can generate fact check data (e.g., true, false, etc.), new facts and/or rules, and/or the like as output and provide such data as input, for example, to classifier 406, filtered knowledge base 412, and/or the like. In some embodiments, the reasoner 404 may provide the new facts/rules generated (e.g., via forward reasoning, etc.) to be included with the filtered knowledge base 412 (e.g., relevant facts, rules, etc.) and used in generating classification data (e.g., labels, etc.) for the query 410. The reasoner 404 can include a forward reasoning module and/or the like that can perform multi-step forward inference. The reasoner 404 can include a backward reasoning module and/or the like that can perform multi-step backward chaining inference. In some embodiments, the reasoner 404 can include trained neural networks that can perform the forward reasoning and the backward reasoning. In some embodiments, the neural networks can be trained using supervised learning. In some embodiments, the reasoner 404 may generate new useful facts (e.g., forward inference, etc.), simpler queries (e.g., backward inference, etc.), and/or the like that may help in labeling queries (e.g., query 410, etc.) more accurately by using logical inference considering rules provided in a knowledge base, for example, filtered knowledge base 412.

The classifier 406 can obtain (e.g., receive, be provided, etc.) the query 410 (e.g., textual classification query, etc.), the filtered knowledge base 412 (e.g., relevant facts, rules, etc.), the backward reasoning data (e.g., fact check data, true/false data, etc.) from reasoner 404, and/or the like. In some embodiments, the classifier 406 can also forward reasoning data from reasoner 404. The classifier 406 can generate label data 416 (e.g., classification label, etc.) for the query 410 and provide the label data 416 (e.g., label, etc.) as output. In some embodiments, the classifier 406 may include a neural network(s) to perform the classification. In some embodiments, the neural network(s) can be trained using supervised learning.

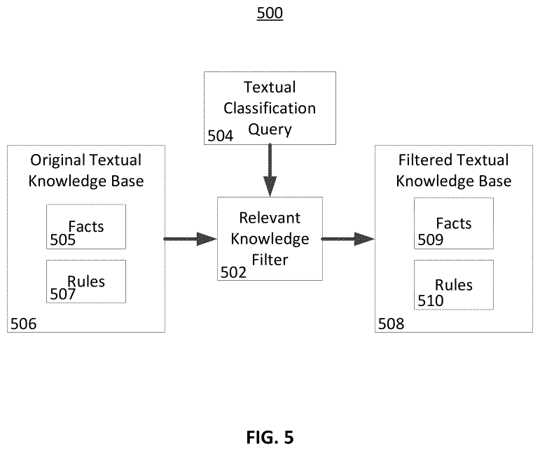

FIG. 5 depicts a block diagram of a knowledge base filtering example 500 of a relevant knowledge filter and associated inputs/outputs, according to embodiments of the present invention. As illustrated in FIG. 5, the relevant knowledge filter 502 can obtain (e.g., receive, be provided, etc.) a textual classification query 504 (e.g., textual query data, etc.), for example, that is to be classified (e.g., labeled, etc.). The relevant knowledge filter 502 can obtain (e.g., access, receive, be provided, etc.) an original textual knowledge base 506 that can include a plurality of facts 505 and rules 507. The relevant knowledge filter 502 can filter (e.g., extract, select, etc.) a subset of data (e.g., facts, rules, etc.) included (e.g., provide, represented, etc.) in the original textual knowledge base 506. The relevant knowledge filter 502 may extract facts and/or rules that be relevant to the textual classification query 504.

For example, the relevant knowledge filter 502 can extract (e.g., obtain, select, generate, etc.) a subset of the facts and/or rules from the original textual knowledge base 506 that may be relevant and/or useful based, at least in part, on textual classification query 504. The relevant knowledge filter 502 can provide (e.g., generate, etc.) a filtered textual knowledge base 508, that includes facts 509 and rules 510 representing a subset of the facts 505 and rules 507 of the original textual knowledge base 506. In some embodiments, a relevant knowledge filter 502 may be implemented using entity linking, similarity search, and/or the like. The relevant knowledge filter 502 can provide the filtered textual knowledge base 508 (e.g., relevant facts 509, relevant rules 510, etc.) for use in generating classification data (e.g., labels, etc.) and/or the like as output in response to the textual classification query 504.

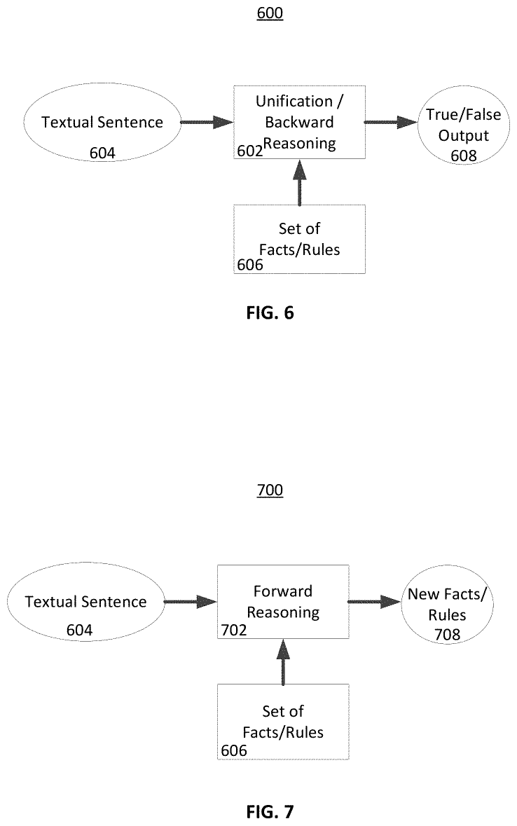

FIG. 6 depicts a block diagram of a backward reasoning example 600 of a backward reasoning module and associated inputs/outputs, according to embodiments of the present invention. As illustrated in FIG. 6, a backward reasoning module 602 can obtain (e.g., receive, be provided, etc.) a textual classification query 604 (e.g., textual query data, sentence in textual form etc.) such as, for example, “q=an elephant in my car”. The backward reasoning module 602 can also obtain (e.g., access, receive, be provided, etc.) a filtered textual knowledge base 606 that includes a set of relevant facts and rules, for example, filtered from a larger textual knowledge base such as described with regard to FIG. 5. As an example, a backward reasoning module 602 may obtain facts such as “elephant is bigger than tiger,” “tiger cannot fit in car,” and/or the like and rules such as “R1: if x does not fit z and y is bigger than x then y cannot fit z” and/or the like. The backward reasoning module 602 can generate true/false output data 608 (e.g., fact check data, etc.) as output, for example, providing a “false” output for an input textual sentence “q=an elephant in my car”. The backward reasoning module 602 can provide true/false output data 608 (e.g., fact check data, etc.), for example to a classifier and/or the like, for use in generating classification data (e.g., labels, etc.) for the textual classification query 604. In some embodiments, the backward reasoning module 602 can include a trained neural network(s) (not shown) that can perform the backward reasoning, including multi-step backward chaining inference. In some embodiments, the backward reasoning module 602 can include a unification neural network that can simulate the unification steps in backward chaining. In some embodiments, the neural network(s) can be trained using supervised learning. In some embodiments, the backward reasoning module 602 can be provided in a reasoner and/or the like, such as described regarding FIG. 4.

FIG. 7 depicts a block diagram of a forward reasoning example 700 of a forward reasoning module and associated inputs/outputs, according to embodiments of the present invention. As illustrated in FIG. 7, a forward reasoning module 702 can obtain (e.g., receive, be provided, etc.) a textual classification query 604 (e.g., textual query data, sentence in textual form etc.) such as, for example, “q=an elephant in my car”. The forward reasoning module 702 can also obtain (e.g., access, receive, be provided, etc.) a filtered textual knowledge base 606 that includes a set of relevant facts and rules, for example, filtered from a larger textual knowledge base such as described with regard to FIG. 5. As an example, a forward reasoning module 702 may obtain facts such as “elephant is the biggest animal in the forest,” “tiger lives in the forest,” and/or the like and rules such as “R1: if x is the biggest in z and y lives in z then xis larger than y” and/or the like. The forward reasoning module 702 can generate new facts and/or rules, such as new facts/rules 708, as output. For example, the forward reasoning module 702 might generate a new fact such as “elephant is bigger than tiger.” The forward reasoning module 702 can generate the new facts/rules 708 based, at least in part, on the textual classification query 604, the filtered textual knowledge base 606, and/or the like. The forward reasoning module 702 can provide the new facts and/or rules, for example, to be added to the filtered textual knowledge base 606, such that the new facts/rules 708 may be used in generating classification data (e.g., labels, etc.) and/or the like for the textual classification query 604. In some embodiments, the forward reasoning module 702 can include a trained neural network(s) (not shown) that can perform the forward reasoning, including multi-step forward inference. For example, in some embodiments, a forward reasoning module 702 neural network can be pretrained to generate new facts given query facts (e.g., from a textual classification query 604, etc.) and multiple rules or facts from a knowledge base, such as provided by the filtered textual knowledge base 606 and/or the like. In some embodiments, the neural network(s) can be trained using supervised learning. In some embodiments, the forward reasoning module 702 can provide for using an input query (e.g., a textual classification query 604, etc.) to guide a reasoner (e.g., including forward reasoning module 702, etc.) to generate facts relevant to a given query (e.g., textual classification query 604, etc.). In some embodiments, the forward reasoning module 702 can be provided in a reasoner and/or the like, such as described regarding FIG. 4.

### Definitions

Present invention: should not be taken as an absolute indication that the subject matter described by the term “present invention” is covered by either the claims as they are filed, or by the claims that may eventually issue after patent prosecution; while the term “present invention” is used to help the reader to get a general feel for which disclosures herein are believed to potentially be new, this understanding, as indicated by use of the term “present invention,” is tentative and provisional and subject to change over the course of patent prosecution as relevant information is developed and as the claims are potentially amended.

Embodiment: see definition of “present invention” above—similar cautions apply to the term “embodiment.”

and/or: inclusive or; for example, A, B “and/or” C means that at least one of A or B or C is true and applicable.

Including/include/includes: unless otherwise explicitly noted, means “including but not necessarily limited to.”

Data communication: any sort of data communication scheme now known or to be developed in the future, including wireless communication, wired communication and communication routes that have wireless and wired portions; data communication is not necessarily limited to: (i) direct data communication; (ii) indirect data communication; and/or (iii) data communication where the format, packetization status, medium, encryption status and/or protocol remains constant over the entire course of the data communication.

Receive/provide/send/input/output/report: unless otherwise explicitly specified, these words should not be taken to imply: (i) any particular degree of directness with respect to the relationship between their objects and subjects; and/or (ii) absence of intermediate components, actions and/or things interposed between their objects and subjects.

Module/Sub-Module: any set of hardware, firmware and/or software that operatively works to do some kind of function, without regard to whether the module is: (i) in a single local proximity; (ii) distributed over a wide area; (iii) in a single proximity within a larger piece of software code; (iv) located within a single piece of software code; (v) located in a single storage device, memory or medium; (vi) mechanically connected; (vii) electrically connected; and/or (viii) connected in data communication.

Computer: any device with significant data processing and/or machine readable instruction reading capabilities including, but not limited to: desktop computers, mainframe computers, laptop computers, field-programmable gate array (FPGA) based devices, smart phones, personal digital assistants (PDAs), body-mounted or inserted computers, embedded device style computers, application-specific integrated circuit (ASIC) based devices.

What is claimed is:

1. A computer-implemented method comprising:
obtaining a textual knowledge base;
filtering the textual knowledge base to obtain a subset of the textual knowledge base, wherein the filtering is based on textual query data;
generating reasoning data based on the subset of the textual knowledge base and the textual query data;
generating classification data based on the subset of the textual knowledge base, the textual query data, and the reasoning data; and
providing label data as output for the textual query data based on the classification data.

2. The computer-implemented method of claim 1, wherein the textual knowledge base includes fact data and rule data.

3. The computer-implemented method of claim 2, further comprising:
generating a human-interpretable explanation responsive to the textual query data based, at least in part on the label data;
wherein the human-interpretable explanation includes facts and rules from the textual knowledge base.

4. The computer-implemented method of claim 3, further comprising:
obtaining feedback related to an answer to a query included in the textual query data, wherein the answer includes the label data provided as output for the textual query data and the human-interpretable explanation responsive to the textual query data; and
providing the feedback for use in updating one or more models used in generating the reasoning data and one or more models used in generating the classification data.

5. The computer-implemented method of claim 1, wherein generating the reasoning data comprises:
generating fact check data by performing backward chaining reasoning based on the subset of the textual knowledge base and the textual query data; and
including the fact check data as part of the reasoning data.

6. The computer-implemented method of claim 5, wherein the backward chaining reasoning comprises performing multi-step backward chaining inference using a pretrained neural network.

7. The computer-implemented method of claim 6, wherein a unification neural network simulates the unification steps in the backward chaining inference.

8. The computer-implemented method of claim 1, wherein generating reasoning data comprises:
performing forward reasoning based on the subset of the textual knowledge base and the textual query data;
generating one or more new facts as output of the forward reasoning; and
providing the one or more new facts to be added to the subset of the textual knowledge base that is provided for generating the classification data.

9. The computer-implemented method of claim 8, wherein the forward reasoning comprises:
performing multi-step forward inference using a neural network;
wherein the textual query data provides a guide for the forward reasoning in generating relevant facts to a given query in the textual query data.

10. The computer-implemented method of claim 1, wherein generating the classification data comprises generating label data for the textual query data using a trained neural network.

11. The computer-implemented method of claim 1, wherein the subset of the textual knowledge base includes a set of facts and rules extracted from the textual knowledge base relevant to the textual query data.

12. The computer-implemented method of claim 11, wherein the filtering of the textual knowledge base is performed by a relevant knowledge filter based in part on entity linking and similarity search.

13. A computer program product comprising a computer readable storage medium having stored thereon:
program instructions programmed to obtain a textual knowledge base, wherein the textual knowledge base includes fact data and rule data;
program instructions programmed to filter the textual knowledge base to obtain a subset of the textual knowledge base, wherein the filtering is based on textual query data;
program instructions programmed to generate reasoning data based on the subset of the textual knowledge base and the textual query data;
program instructions programmed to generate classification data based on the subset of the textual knowledge base, the textual query data, and the reasoning data; and
program instructions programmed to provide label data as output for the textual query data based on the classification data.

14. The computer program product of claim 13, wherein generating the reasoning data comprises the computer readable storage medium having further stored thereon:
program instructions programmed to generate fact check data by performing backward chaining reasoning based on the subset of the textual knowledge base and the textual query data; and
program instructions programmed to include the fact check data as part of the reasoning data.

15. The computer program product of claim 13, wherein generating reasoning data comprises the computer readable storage medium having further stored thereon:
program instructions programmed to perform forward reasoning based on the subset of the textual knowledge base and the textual query data;
program instructions programmed to generate one or more new facts as output of the forward reasoning; and
program instructions programmed to provide the one or more new facts to be added to the subset of the textual knowledge base that is provided for generating the classification data.

16. The computer program product of claim 13, wherein the subset of the textual knowledge base includes a set of facts and rules extracted from the textual knowledge base relevant to the textual query data.

17. A computer system comprising:
a processor set; and
a computer readable storage medium;
wherein:
the processor set is structured, located, connected and programmed to run program instructions stored on the computer readable storage medium; and
the stored program instructions include:
program instructions programmed to obtain a textual knowledge base, wherein the textual knowledge base includes fact data and rule data;
program instructions programmed to filter the textual knowledge base to obtain a subset of the textual knowledge base, wherein the filtering is based on textual query data;
program instructions programmed to generate reasoning data based on the subset of the textual knowledge base and the textual query data;
program instructions programmed to generate classification data based on the subset of the textual knowledge base, the textual query data, and the reasoning data; and
program instructions programmed to provide label data as output for the textual query data based on the classification data.

18. The computer system of claim 17, wherein generating the reasoning data comprises the stored program instructions further including:
program instructions programmed to generate fact check data by performing backward chaining reasoning based on the subset of the textual knowledge base and the textual query data;
program instructions programmed to include the fact check data as part of the reasoning data;
program instructions programmed to perform forward reasoning based on the subset of the textual knowledge base and the textual query data;
program instructions programmed to generate one or more new facts as output of the forward reasoning; and
program instructions programmed to provide the one or more new facts to be added to the subset of the textual knowledge base that is provided for generating the classification data.

19. The computer system of claim 18, wherein:
the backward chaining reasoning includes performing multi-step backward chaining inference using a neural network; and
the forward reasoning includes performing multi-step forward inference using a neural network.

20. The computer system of claim 17, wherein the subset of the textual knowledge base includes a set of facts and rules extracted from the textual knowledge base relevant to the textual query data.
